(19) United States
(12) Patent Application Publication
(10) Pub. No.: US 2020/0222816 A1
(43) Pub. Date: Jul. 16, 2020

(54) PORTABLE MEDIA CASE

(71) Applicants: Dean Thomas Mercier, Redmond, WA (US); Chris Apland, Redmond, WA (US)

(72) Inventors: Dean Thomas Mercier, Redmond, WA (US); Chris Apland, Redmond, WA (US)

(73) Assignee: G.A.E.M.S, INC., Redmond, WA (US)

(21) Appl. No.: 16/740,067

(22) Filed: Jan. 10, 2020

Related U.S. Application Data
(63) Continuation of application No. PCT/US2018/041690, filed on Jul. 11, 2018.
(60) Provisional application No. 62/531,309, filed on Jul. 11, 2017.

(51) Int. Cl. A63F 13/98

(52) U.S. Cl. CPC A63F 13/98

(57) ABSTRACT

Generally described, aspects of the disclosed subject matter are directed to portable gaming, entertainment, and media cases. The case generally includes an enclosure having a base and a lid hingedly coupled to the base. The lid includes a video display and is pivotable between an open position, such that the display is viewable, and a closed position. The enclosure includes a retaining bracket to form a console chamber partially surrounding and retain a gaming, media, or other console. The case includes one or more interface panels with communication ports accessible with the lid in the open position. The enclosure may be configured to maintain electrical communication between the first interface panel and the video display while the lid pivots between the open and closed positions. The enclosure may include a power supply for providing electrical power to at least one of the video display, the interface panels, and the console.

### CROSS-REFERENCES TO RELATED APPLICATIONS

This application is a continuation of International Application No. PCT/US2018/041690, filed Jul. 11, 2018, which claims the benefit of U.S. Provisional Application No. 62/531,309, filed Jul. 11, 2017, the disclosures of which are hereby expressly incorporated by reference in their entirety.

### BACKGROUND

Many people enjoy playing games on and otherwise utilizing gaming and entertainment consoles, such as Microsoft's XBOX®, Sony's PLAYSTATION®, Nintendo's WII®, and the like. Gaming consoles and personal computer (PC) gaming systems are generally configured to receive a game or entertainment source, typically an optical disc (e.g., a CD or DVD), Digital File Transfer, or Streamed Digital Content from another device, and allow the user to play and/or watch the game, movie or other entertainment material on the game console. Most game consoles are adapted to play specially configured games that take advantage of the visual and audio aspects of the particular game console. In addition, game consoles may also be configured to play standard movies, music, and other entertainment materials that are available on CDs, DVDs, BLU-RAY DISC®, Digital Content, and the like.

The most commonly utilized game consoles are also configured to allow the user to connect to the Internet, a local area network (LAN), or wide area network (WAN), through a wired or wireless connection, directly or indirectly, to transmit and receive data, particularly gaming data, with other persons, servers, systems, or websites. In one example, a person playing a game on a game console can communicate with others, whether located nearby or in a different country, to play multi-player games.

Game consoles are typically sold as a unit that includes the console, one or more game playing devices (commonly referred to as “controllers”), and various wires and cables to operate the game console and connect to a display. Game consoles are generally not sold with any video or audio playing devices. Instead, a person wanting to utilize the game console must connect it to a television, monitor, or other video display device on which the game or movie will be displayed. In a similar manner, the audio portion of the game console requires feeding the audio signal through the video device, such as a television or monitor having speakers attached thereto, connect the game console to one or more external speakers, or utilize another type of audio device to project the audio portion of the game or movie.

Some users of game consoles prefer the requirement for peripheral video and audio devices such that they can specify each device to their personal preference, based on size, cost, availability, performance, and other factors. Requiring peripheral devices for the video and audio of a game console limits portability in contrast to laptops and similar portable computing devices, which generally have fixedly attached display monitors and speakers.

Users generally play games on the game consoles by themselves (e.g., competing against a computerized opponent or algorithm), or compete against other players as opponents. Users may compete with other players remotely, such as over the Internet, or in physical proximity, using either the same game console and the same video and audio devices, by connecting to a jointly utilized multi-game console configuration, or with separate devices over a LAN.

Game consoles generally support multi-player sessions using a single game console. To facilitate multi-player use, game consoles typically have connection ports for multiple controllers configured to feed input signals to the game. Game consoles may also facilitate joint play by multiple players in proximity by dividing a single visual display into multiple or split screens that allow each person to see and control their own game play. Some users consider split screens a drawback because the configuration results in a smaller visual display of their play, and creates a visual distraction by having the other player's screens adjacent their own screen. In some cases, a split screen may give the opponent an advantage by allowing the opponent to see the screen their competitors, thereby allowing a player to view the movements or other action in a manner that reduces competitive play.

The various limitations of split screen game play are avoided if each player has a game console with separate video and audio devices. Conventional game consoles require each player to transport video and audio devices to a gaming location, and perform a setup the game console (e.g., connect the peripheral devices to the game console). Transportation of peripheral devices poses a risk of damage by impact, abrasion, vibration, or the like.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a portable gaming and entertainment system is provided. The portable gaming and entertainment system generally includes an enclosure having a base portion and a lid hingedly coupled to the base portion, the lid pivotable between an open position and a closed position; a retaining bracket couplable to the base portion to form a console chamber with the base portion, the retaining bracket configured to partially surround and retain a console within the console chamber; a video display coupled to the lid and configured to be viewable in the open position; and a first interface panel associated with the base portion and having a first port accessible with the lid in the open position, the enclosure configured to maintain electrical communication between the first interface panel and the video display while the lid pivots between the open and closed positions.

In accordance with another embodiment of the present disclosure, a portable media case is provided. The portable media case generally includes an enclosure having a base portion and a lid hingedly coupled to the base portion, the lid pivotable between an open position and a closed position; a retaining bracket couplable to the base portion to form a console chamber with the base portion, the retaining bracket configured to partially surround and retain a console within the console chamber; a video display coupled to the lid and configured to be viewable in the open position; a first interface panel associated with the base portion and having a first port accessible with the lid in the open position; and a power supply removably couplable to the base portion for providing electrical power to at least one of the video display, the first interface panel, and the console.

In accordance with another embodiment of the present disclosure, a portable media case is provided. The portable media case generally includes an enclosure having a base portion and a lid hingedly coupled to the base portion, the lid pivotable between an open position and a closed position; a retaining bracket couplable to the base portion to form a console chamber with the base portion, the retaining bracket configured to partially surround and retain a console within the console chamber; a video display means coupled to the lid and configured to be viewable in the open position; a first interface panel associated with the base portion and having a communication means accessible with the lid in the open position; and a power supply removably couplable to the base portion for providing electrical power to at least one of the video display, the first interface panel, and the console.

In accordance with another embodiment of the present disclosure, a portable media case for a console is provided. The portable media case for a console generally includes an enclosure surrounding the console and having a base portion and a lid hingedly coupled to the base portion, the lid pivotable between an open position and a closed position; a retaining bracket couplable to the base portion to form a console chamber with the base portion, the retaining bracket configured to partially surround and retain the console within the console chamber; a video display coupled to the lid and configured to be viewable in the open position; and a first interface panel associated with the base portion and having a first port accessible with the lid in the open position, the enclosure configured to maintain electrical communication between the first interface panel and the video display while the lid pivots between the open and closed positions.

In accordance with any of the embodiments described herein, the portable media case further comprises a second interface panel in electrical communication with the first interface panel and positioned near a front end of the base portion, the second interface panel having a second port accessible with the lid in the open position.

In accordance with any of the embodiments described herein, the first and second ports may be selected from the group consisting of USB, HDMI™, DISPLAYPORT™, VGA, DVI, optical, audio, video, AC power socket, etc.

In accordance with any of the embodiments described herein, the retaining bracket may include an adaptable insert to conform to the shape of the console to securely retain the console within the console chamber.

In accordance with any of the embodiments described herein, the portable media case may further comprise a power supply removably couplable to the base portion for providing electrical power to at least one of the video display, the first interface panel, and the console.

In accordance with any of the embodiments described herein, the lid may include a peripheral rail for mounting a peripheral device selected from the group consisting of a microphone, a camera, a light, an antenna, a display, and the like.

In accordance with any of the embodiments described herein, the lid may include an access panel for service or removal of the video display.

In accordance with any of the embodiments described herein, the portable media case may further comprise a lid hinge coupling the lid to the base portion, wherein the lid hinge may facilitate the electrical communication between the first interface panel and the video display.

In accordance with any of the embodiments described herein, the retaining bracket may be hingedly coupled to the base portion.

In accordance with any of the embodiments described herein, the portable media case may further comprise a user input panel configured to communicate input from a user to at least one of the first interface panel, the video display, and the console.

In accordance with any of the embodiments described herein, the portable media case may further comprise a peripheral retainer for coupling a peripheral of the system to the base portion.

In accordance with any of the embodiments described herein, the enclosure may be configured to maintain electrical communication between the first interface panel and the video display while the lid pivots between the open and closed positions.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is front left top perspective view of one representative embodiment of a portable media case in accordance with an aspect of the present disclosure, showing a lid of an enclosure in a closed position;

FIG. 2 is a front left top perspective view of the portable media case of FIG. 1, showing the lid of the enclosure in an open position, and a retaining bracket in a secured position;

FIG. 3 is a front right top perspective view of the portable media case of FIG. 1, showing the lid of the enclosure in the open position, and the retaining bracket in an unsecured position; and

FIG. 4 is a top view of the portable media case of FIG. 1, showing the lid of the enclosure in the open position, and the retaining bracket in the secured position.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as precluding other embodiments. The illustrative examples provided herein are not intended to be exhaustive or to limit the disclosure to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “forward,” “rearward,” “front,” “rear,” “upward,” “downward,” “top,” “bottom,” “right hand,” “left hand,” “lateral,” “medial,” “in,” “out,” “extended,” etc. These references, and other similar references in the present application, are only to assist in helping describe and to understand the particular embodiment and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, lists of two or more elements of the form, for example, “at least one of A, B, and C,” is intended to mean (A), (B), (C), (A and B), (A and C), (B and C), or (A, B, and C), and further includes all similar permutations when any other quantity of elements is listed.

The following description provides several examples that relate to portable media cases, such as cases that are configured to retain and enclose gaming consoles, PCs, peripherals, video displays, controllers, CPUs, and the like. In this regard, embodiments of the portable media case disclosed herein are capable of retaining and enclosing any suitable system. Hereinafter, gaming and/or entertainment consoles, PCs, CPUs, etc. are generally referred to as a “console” or “game console.”

Embodiments of the portable media case are generally configured to retain and enclose a gaming console or small form factor PC. In some embodiments, the portable media case provides power, by power electronics configured to draw power from a power outlet or battery, to one or more of the console, a video display communicatively coupled to the console, and console peripherals (such as a game controller, game pad, keyboard, mouse, and the like). In some embodiments, the portable media case is configured to accommodate other video display dependent hardware, such as a Drone/UAV, a DVD Player, and the like, and is also within the scope of the present disclosure.

In some conventional portable media cases, the console, the video display, and any peripherals must be separately connected for electronic communication and for electrical power they must be plugged into a wall power outlet (110-240 volts). In these conventional portable media cases, all connections to the console, video display, and peripherals must be disconnected prior to closing the case for transport and storage. In this regard, the connections and power cables must all be reconnected each time the portable media case is used. Contrastingly, in embodiments of the present disclosure, a suitable power supply is positioned in the case to provide power to one or more of the console, video display, and peripherals. In some embodiments of the present disclosure, only a single power cable is plugged into a wall power outlet, and provides electrical power to each component within the case.

Likewise, in some conventional portable media cases, each electrical communication connection, such as video or audio communication connections, must be disconnected prior to closing the case for transport of storage due to the potential to pinch and sever the cables. Contrastingly, in some embodiments of the present disclosure, the portable media case is configured to safely maintain electrical communication connections while the case is closed for transport and storage. In these embodiments, the electrical communication connections are not required to be disconnected and reconnected each time the portable media case is used.

Embodiments of the portable media case disclosed herein may include a retaining bracket to surround and retain the console. In some embodiments the retaining bracket is configured to conform to the shape of a certain console, such as Nintendo's WIT®. In these embodiments, the retaining bracket closely conforms to the shape of the console to protect the console from shifting, vibration, impact, and other potential damaging movements while the portable media case is being transported. In some embodiments, the retaining bracket includes shock-absorbing and/or compressible materials, such as foam or rubber, to protect the console. In other embodiments, the retaining bracket is configured to conform to the shape of multiple consoles, and may include removably couplable portions to customize and/or conform the shape of the retaining bracket to the shape of the console stored in the portable media case. In further embodiments, the retaining bracket is any suitable shape to retain and protect the console within the portable media case.

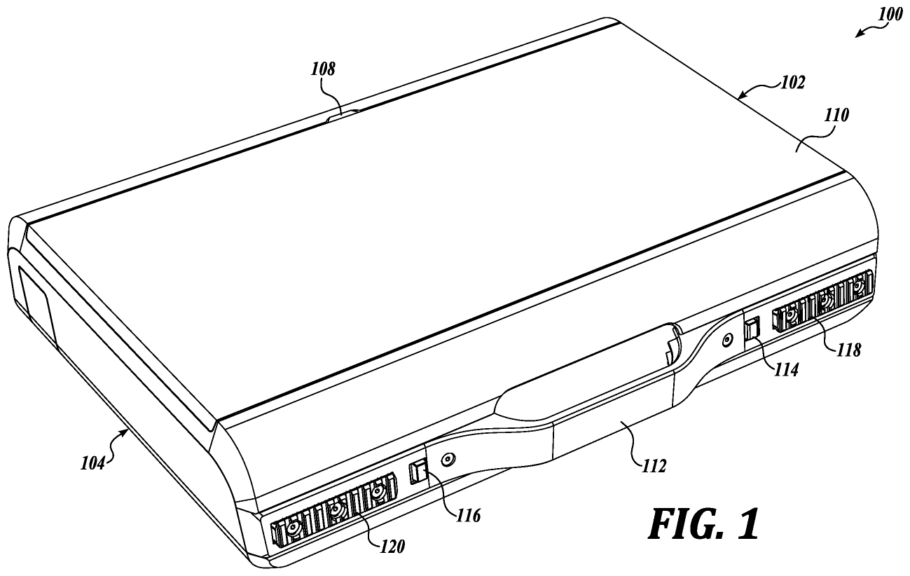

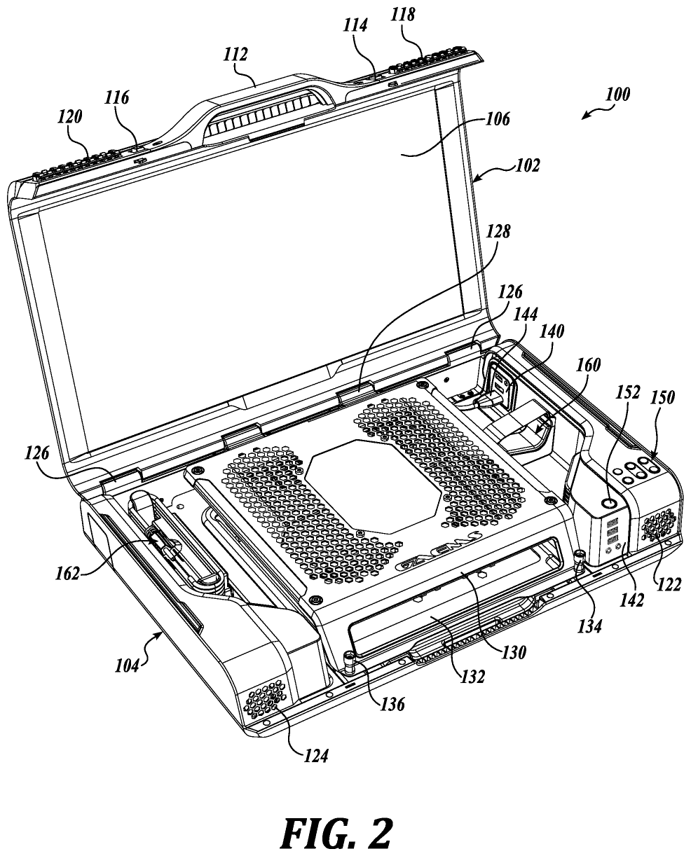

Referring initially to FIG. 1, a representative embodiment of a portable media case for use with a console (not shown) is depicted, generally denoted as an enclosure 100. The enclosure 100 is shown in a closed position, such as a position that is used when the portable media case is stored, transported, or otherwise not in use. The enclosure 100 generally includes a lid 102, a base portion 104, and a carrying handle 112. In some embodiments, the lid 102 includes an access groove 108 for the opening of a removable access panel 110 to adjust, service, and/or remove and replace a video display 106 (see FIG. 2). In the illustrated embodiments, the lid 102 is hingedly coupled to the base portion 104, such that the lid 102 is pivotable from a closed position (FIG. 1), to an open position (FIGS. 2-4) such that the video display 106 and other components within the enclosure 100 are accessible.

In some embodiments, the lid 102 also includes a first latch 114 and a second latch 116 for securing the lid 102 to the base portion 104 in the closed position. In other embodiments, a single latch, or more than two latches are used to secure the lid 102 to the base portion 104 to close the enclosure 100. In some embodiments, the lid 102 and/or the base 104 include peripheral mounts, such as a first peripheral rail 118 and a second peripheral rail 120. In these embodiments, the first and second peripheral rails 118 and 120 may be of an industry standard configuration mounts, such that a variety of mountable devices can be attached, for example, a microphone, a camera, a light, an antenna, a display, and the like. In one embodiment, the first and second peripheral rails 118 and 120 are “Picatinny” type rails, commonly used with firearms and other components. In other embodiments, the first and second peripheral rails 118 and 120 are any suitable type of mount to attach one or more mountable devices.

Turning now to FIG. 2, the enclosure 100 is shown with the lid 102 in the open position, revealing components within the enclosure 100. In the open position, the video display 106 is shown coupled to an inner surface of the lid 102. In this regard, the video display 106 is viewable while the lid 102 is in the open position. The video display 106 in some embodiments can be any suitable display capable of displaying standard definition video, high definition video, or ultra-high definition video, such as a plasma display, a LCD display, a LED display, an OLED display, etc. In some embodiments, the lid 102 is hingedly coupled to the base portion 104 by a lid hinge 126. In one embodiment, the lid hinge 126 is configured to position the lid 102 in a variety of angles from the base portion 104, such that the video display 106 can be positioned for an optimal viewing angle when the portable media case is in use. In this embodiment, the lid hinge 126 may be configured to provide an amount of resistance (generally referred to as a “pressure hinge”) to rotation of the lid 102 such that the lid 102 is retained in an angular position. In the illustrated embodiment, two lid hinges 126 are shown, coupling the lid 102 to the base portion 104. In other embodiments, any number of lid hinges 126 or other means can be suitably used to couple the lid 102 to the base portion 104.

In some embodiments, the enclosure 100 includes a first speaker 122 and a second speaker 124 to provide audio output for the portable media case. In these embodiments, the first and second speakers 122 and 124 includes suitable electrical audio connections to various components of the enclosure, such that audio signals from the console are transmitted to the first and second speakers 122 and 124 for production of the audio. In some embodiments, multiple drivers are included at each speaker location (not shown) within the enclosure 100, such as to provide separation between bass, middle, and treble ranges of audio. In other embodiments, various ports, baffles, and the like are suitably included to improve the quality of the reproduced audio.

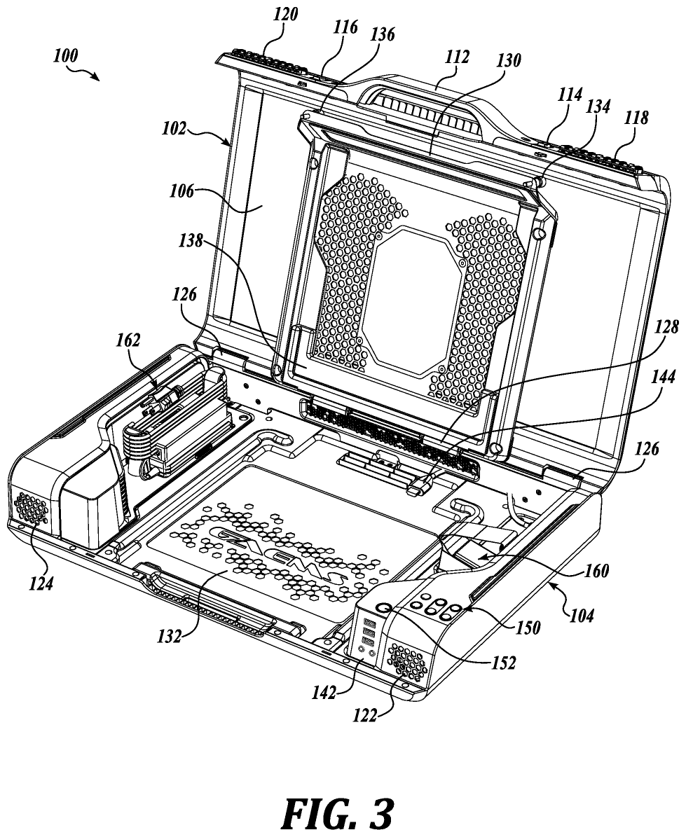

In embodiments of the present disclosure, the enclosure 100 generally includes a retaining bracket 130 to partially surround and retain the console within a console chamber 132. As shown in the transition from FIG. 2 to FIG. 3, in some embodiments, the retaining bracket 130 is configured to transition from a secured position (FIG. 2) to an unsecured position (FIG. 3) for insertion and removal of the console.

In the illustrated embodiment, the retaining bracket 130 is hingedly coupled to the base portion 104 by a retaining bracket hinge 128. In some embodiments, when the retaining bracket 130 is rotated to the secured position, a first retaining bracket fastener 134 and a second retaining bracket fastener 136 are suitably used to secure the retaining bracket 130 in the secured position, thereby retaining the console within the console chamber 132. In other embodiments, any suitable fastening device is used to secure the retaining bracket 130 and the secured position, such as a latch, pin, twist-to-lock, hook-and-loop, or the like. In further embodiments, the retaining bracket 130 is not hingedly coupled to the base portion 104, but is couplable to the base portion 104 by any suitable fastener system. Still, in further embodiments, the base portion 104 includes a screw boss (not shown) to secure a custom retaining bracket or mounting system for retaining further devices in the console chamber 132.

As described above and shown in FIG. 3, in some embodiments, the retaining bracket 130 may include a conforming portion 138, such as an insert, configured to conform to the shape of the console for improved retention of the console within the console chamber 132. In some embodiments, the enclosure 100 includes suitable conforming portions 138 to adapt to multiple console configurations. In this regard, the enclosure 100 is capable of retaining a variety of console shapes, such that the enclosure 100 may be used with multiple consoles without the need to obtain a portable media case specifically designed for one console. In these embodiments, the conforming portion 138 is coupled to the retaining bracket 130 by any suitable means, such as adhesive, peel-and-stick, hook-and-loop, fasteners, and the like. In some embodiments, multiple conforming portions 138 are used to conform to the shape of the console for retention within the console chamber 132.

Returning now to FIG. 2, in some embodiments, the enclosure 100 includes one or more interface panels, such as a first interface panel 140 and a second interface panel 142. In these embodiments, the first and second interface panels 140 and 142 are configured to provide one or more ports for electrically connecting various components of the enclosure 100. In some embodiments, the ports are configured to electrically communicate using a connector having a standard configuration, such as USB, HDMI™, DISPLAYPORT™, VGA, DVI, optical, audio, video, AC power socket, etc. In other embodiments, the ports are of any suitable configuration for electrical communication between components of the enclosure 100 and/or peripherals. In one embodiment shown in FIGS. 2-4, the first interface panel 140 is connected to a connection cable 144. In this embodiment, the connection cable 144 is suitably an HDMI™ cable for connecting to a video port of the console for the transmission of the video signal from the console to the first interface panel 140. In other embodiments, any connection cable configuration is within the scope of the present disclosure.

In some embodiments, the first interface panel 140 is in electrical communication with the video display 106, such that a video signal may be transmitted from the interface panel 140 to the video display 106. In these embodiments, any suitable connection between the first interface panel 140 and the video display 106 is within the scope of the present disclosure. In one embodiment, the connection between the first interface panel 140 and the video display 106 is routed through the lid hinge 126, such that when the lid 102 is transitioned between the open position and the closed position, the connection between the first interface panel 140 in the video display 106 is not pinched, stressed, or otherwise damaged. In this embodiment, a cable, wires, or other circuits may be embedded within the lid hinge 126, or routed adjacent or through the lid hinge 126. Although the first interface panel 140 is shown positioned in a right hand rear area of the enclosure 100, in other embodiments, the first interface panel 140 is positioned in any location of the enclosure 100.

In some embodiments, the second interface panel 142 is included in the enclosure 100 in a separate location from the first interface panel 140. In these embodiments, the second interface panel 142 may include any number of suitable ports or interfaces for electrical communication with the first interface panel 140, the video display 106, the console, or any other peripheral or component of the enclosure 100. In the illustrated embodiment, the second interface panel 142 is accessible near the front of the enclosure 100 when the lid 102 is in the open position.

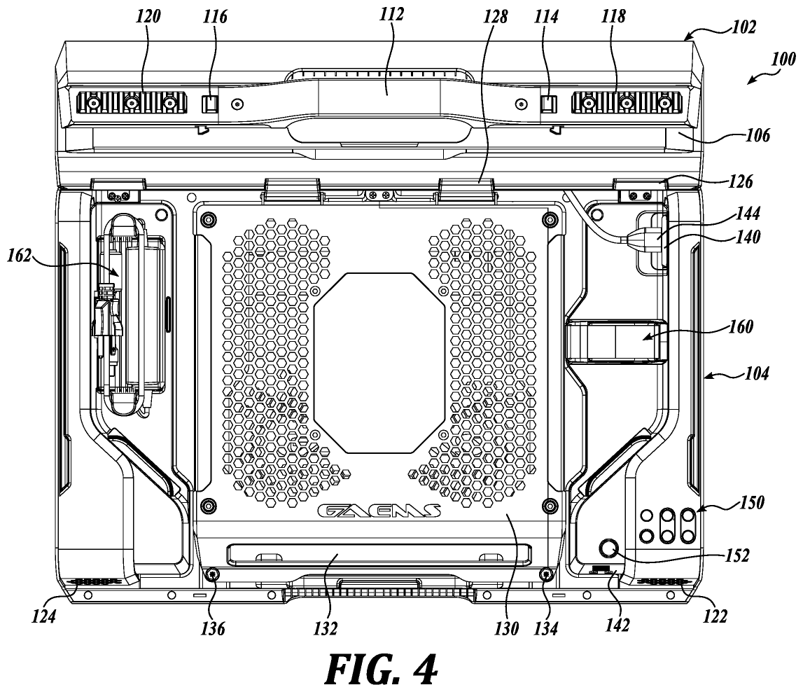

As shown most clearly in FIGS. 3-4, in some embodiments, the enclosure 100 includes an input panel 150 comprising one or more input devices, such as a switch or button. In these embodiments, the input panel 150 may include various user input features, such as audio volume, display adjustments, connection switching, menu selections, peripheral activation, and the like. In these embodiments, the various user input devices of the input panel 150 are electrically connected to one or more of the first interface panel 140, the second interface panel 142, the video display 106, the console, and any other peripheral or component of the enclosure 100. In the illustrated embodiment, the enclosure 100 also includes a power switch 152 for selectively powering one or more of the components of the enclosure 100, such as the first and second interface panels 140 and 142, the video display 106, the console, and the like.

In some embodiments, the enclosure 100 includes a peripheral retainer 160 configured to retain a variety of peripheral devices, such as controllers, power supplies, cables, input devices, and the like. In these embodiments, a cover panel (not shown) may be included to enclose the peripheral retainer 160. In other embodiments, the enclosure 100 includes a power supply 162 to provide electrical power to one or more of the components of the enclosure 100, such as the video display 106, the first and second panels 140 and 142, the console, and peripherals or other components of the enclosure 100. In this regard, the power supply 162 may be configured to supply power to multiple components such that only a single electrical connection to a wall outlet is required. In some embodiments, the power supply 162 includes one or more circuits configured for power management, power conditioning, power conversion, power distribution, etc. In other embodiments, the power supply 162 includes one or more batteries for powering components of the enclosure 100 without an external power source.

In some embodiments, the enclosure 100 includes a cooling fan (not shown) to provide forced convection cooling to various components of the enclosure. In these and other embodiments, various ventilation ports are included in the enclosure 100 to allow circulation of air through the enclosure 100 to provide cooling.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A portable gaming and entertainment system, comprising:
an enclosure having a base portion and a lid hingedly coupled to the base portion, the lid pivotable between an open position and a closed position;
a retaining bracket couplable to the base portion to form a console chamber with the base portion, the retaining bracket configured to partially surround and retain a console within the console chamber;
a video display coupled to the lid and configured to be viewable in the open position; and
a first interface panel associated with the base portion and having a first port accessible with the lid in the open position, the enclosure configured to maintain electrical communication between the first interface panel and the video display while the lid pivots between the open and closed positions.

2. The portable gaming and entertainment system of claim 1, further comprising a second interface panel in electrical communication with the first interface panel and positioned near a front end of the base portion, the second interface panel having a second port accessible with the lid in the open position.

3. The portable gaming and entertainment system of claim 2, wherein the first and second ports are selected from the group consisting of USB, HDMI™, DISPLAYPORT™, VGA, DVI, optical, audio, video, and a AC power socket.

4. The portable gaming and entertainment system of claim 1, wherein the retaining bracket includes an adaptable insert to conform to the shape of the console to securely retain the console within the console chamber.

5. The portable gaming and entertainment system of claim 1, further comprising a power supply removably couplable to the base portion for providing electrical power to at least one of the video display, the first interface panel, and the console.

6. The portable gaming and entertainment system of claim 1, wherein the lid includes a peripheral rail for mounting a peripheral device selected from the group consisting of a microphone, a camera, a light, an antenna, and a display.

7. The portable gaming and entertainment system of claim 1, wherein the lid includes an access panel for service or removal of the video display.

8. The portable gaming and entertainment system of claim 1, further comprising a lid hinge coupling the lid to the base portion, wherein the lid hinge facilitates the electrical communication between the first interface panel and the video display.

9. The portable gaming and entertainment system of claim 1, wherein the retaining bracket is hingedly coupled to the base portion.

10. The portable gaming and entertainment system of claim 1, further comprising a user input panel configured to communicate input from a user to at least one of the first interface panel, the video display, and the console.

11. The portable gaming and entertainment system of claim 1, further comprising a peripheral retainer for coupling a peripheral of the system to the base portion.

12. A portable media case, comprising:
an enclosure having a base portion and a lid hingedly coupled to the base portion, the lid pivotable between an open position and a closed position;
a retaining bracket couplable to the base portion to form a console chamber with the base portion, the retaining bracket configured to partially surround and retain a console within the console chamber;
a video display coupled to the lid and configured to be viewable in the open position;
a first interface panel associated with the base portion and having a first port accessible with the lid in the open position; and
a power supply removably couplable to the base portion for providing electrical power to at least one of the video display, the first interface panel, and the console.

13. The portable media case of claim 12, wherein the enclosure is configured to maintain electrical communication between the first interface panel and the video display while the lid pivots between the open and closed positions.

14. The portable media case of claim 13, further comprising a lid hinge coupling the lid to the base portion, wherein the lid hinge facilitates the electrical communication between the first interface panel and the video display.

15. The portable media case of claim 1, further comprising a second interface panel in electrical communication with the first interface panel and positioned near a front end of the base portion, the second interface panel having a second port accessible with the lid in the open position.

16. The portable media case of claim 15, wherein the first and second ports are selected from the group consisting of USB, HDMI™, DISPLAYPORT™, VGA, DVI, optical, audio, video, and an AC power socket.

17. The portable media case of claim 1, wherein the retaining bracket includes an adaptable insert to conform to the shape of the console to securely retain the console within the console chamber.

18. The portable media case of claim 1, wherein the lid includes a peripheral rail for mounting a peripheral device selected from the group consisting of a microphone, a camera, a light, an antenna, and a display.

19. (canceled)

20. The portable media case of claim 1, further comprising a user input panel configured to communicate input from a user to at least one of the first interface panel, the video display, and the console.

21. (canceled)

22. A portable media case for a console, comprising:
an enclosure surrounding the console and having a base portion and a lid hingedly coupled to the base portion, the lid pivotable between an open position and a closed position;
a retaining bracket couplable to the base portion to form a console chamber with the base portion, the retaining bracket configured to partially surround and retain the console within the console chamber;
a video display coupled to the lid and configured to be viewable in the open position; and
a first interface panel associated with the base portion and having a first port accessible with the lid in the open position, the enclosure configured to maintain electrical communication between the first interface panel and the video display while the lid pivots between the open and closed positions.
